(19) United States
(12) Patent Application Publication
(10) Pub. No.: US 2026/0161740 A1
(43) Pub. Date: Jun. 11, 2026

(54) RECOMMENDATION SYSTEM AND RECOMMENDATION METHOD FOR INFERRING EDGE INFORMATION IN A HYPERBOLIC SPACE AND PERFORMING USER-SPECIFIC RECOMMENDATION

(71) Applicant: Korea Institute of Energy Technology, Jeollanam-do (KR)

(72) Inventors: Chong Kwon KIM, Gwangju (KR); Yoon Hyuk CHOI, Seoul (KR); Tae Wook KO, Seoul (KR)

(21) Appl. No.: 19/408,377

(22) Filed: Dec. 4, 2025

(30) Foreign Application Priority Data
Dec. 6, 2024 (KR) 10-2024-0180913
Sep. 24, 2025 (KR) 10-2025-0137767

(51) Int. Cl. G06F 18/2134; G06F 18/15; G06F 18/22; G06N 3/0464; G06N 5/04

(52) U.S. Cl. CPC G06F 18/21347; G06F 18/15; G06F 18/22; G06N 3/0464; G06N 5/04

(57) ABSTRACT

The present invention relates to a recommendation method for performing personalized recommendation by inferring edge information in a hyperbolic space and, more particularly, to a technique in which a recommendation system server collects review data corresponding to users and items, generates review document vectors and maps the review document vectors into the hyperbolic space, computes similarity scores based on hyperbolic distances, infers edge existence probabilities through a link prediction neural network, and generates a final recommended item list for each user by reflecting domain-shared features across multiple domains.

### CROSS-REFERENCE TO RELATED APPLICATION

This application claims priority from and the benefit of Korean Patent Application No. 10-2024-0180913 filed on Dec. 6, 2024, No. 10-2025-0137767 filed on Sep. 24, 2025, in the Korean Intellectual Property Office, the disclosure of which is incorporated herein by reference.

### BACKGROUND OF THE DISCLOSURE

### Field of the Disclosure

Example embodiments relate to a recommendation method for performing user-specific recommendations by inferring edge information in a hyperbolic space, and more particularly to a technology in which a recommendation system server collects review data corresponding to users and items, generates review document vectors and maps the review document vectors into a hyperbolic space, computes similarity scores based on hyperbolic-space distances, infers edge existence probabilities through a link prediction neural network, and generates, for each user, a final recommended item list by reflecting domain-shared features across multiple domains.

### Description of the Related Art

A recommendation system has evolved into approaches such as content-based filtering, collaborative filtering (CF), and hybrid methods.

Meanwhile, a content-based recommendation system analyzes attributes of items that a user has preferred in the past and recommends items having similar attributes.

In addition, a collaborative filtering system recommends items on the basis of similarities in behavior patterns among users, and initially started from memory-based CF (User-User, Item-Item) methods and has evolved into latent factor-based matrix factorization methods. Recently, deep learning-based recommendation systems (DLRS) have been spreading in the recommendation field, and active research has been conducted on processing unstructured data and learning high-dimensional representations by utilizing various models such as CNNs, RNNs, and GNNs (Graph Neural Networks).

In recent studies, GNN-based recommendation techniques that model interactions between users and items as a graph and utilize graph signals and edge information have been spreading.

Representative techniques include Graph Convolutional Networks (GCN), Graph Attention Networks (GAT), and LightGCN, and these techniques are capable of learning user-item relationships in a multi-layer manner and reflecting complex non-linear patterns. However, since GNNs are mainly trained in a Euclidean space, they have limitations in effectively representing hierarchical relations or sparse high-dimensional structures. Accordingly, in recent years, research on hyperbolic space-based recommendation has attracted attention in academia.

Hyperbolic embedding utilizes a non-Euclidean space having negative curvature to map users and items into a hyperbolic space, and operates in such a manner that similarities between users and items are calculated on the basis of hyperbolic distances. Hyperbolic space is particularly efficient for representing tree structures or hierarchical data, and representative techniques include Poincare embedding and the Lorentz model. This technology can improve both recommendation accuracy and the ability to preserve hierarchical relations, and is therefore being increasingly adopted in various fields such as e-commerce, content streaming, and social networks.

However, conventional Euclidean space-based recommendation systems have a limitation in that they lack expressive power for hierarchical data. Most conventional deep learning models and matrix factorization-based models learn user and item vectors in a Euclidean space, and thus suffer from significantly reduced representational efficiency when data has a complex hierarchical structure.

In addition, recommendation systems have difficulty solving a cold start problem for new users and new items due to sparsity of user-item interaction data. In environments where characteristics of domains are heterogeneous, such as e-commerce, video platforms, and social network services (SNS), there is a limitation in capturing common patterns only with Euclidean space-based vector representations.

Graph-based recommendation systems also suffer from issues in terms of scalability. Since the computational complexity of GNN-based recommendation systems sharply increases as the number of nodes increases, they exhibit low scalability in large-scale service environments in which hundreds of thousands to millions of users and items are processed simultaneously. Furthermore, conventional GNN models are often trained in a single domain, and thus it is difficult to integrally learn and utilize user behavior data across different categories.

Hyperbolic space-based recommendation techniques also have several limitations.

First, computation of hyperbolic distances requires complex operations in a high-dimensional space, and therefore training time is longer and optimization is more difficult than in conventional Euclidean space-based operations.

In addition, due to characteristics of hyperbolic space, there is a restriction in terms of model interpretability in that it is difficult to visually interpret hierarchical structures learned by a model or to explain recommendation results. Moreover, many existing studies are limited to specific single domains such as movies and music, and therefore have limitations in integrally learning and utilizing data from multiple platforms in an actual service environment.

Finally, there is a problem in that existing research is insufficient in terms of finely inferring edge existence probabilities representing relationships between users and items, and thus the potential of hyperbolic space is not fully exploited and recommendation accuracy is limited.

Korean registered patent no. 10-2837891, entitled “Platform for providing AI-based user-customized career exploration” Korean registered patent no. 10-2847307, entitled “artificial intelligence-based user-customized plant recommendation method and plant management system performing the same”

### SUMMARY

The present invention is directed to mapping users and items into a hyperbolic space and inferring edge information so as to precisely predict relationships between users and relationships between users and items.

The present invention is directed to improving recommendation accuracy in a hyperbolic space by simultaneously reflecting graph signals and user-item interaction data.

The present invention is directed to estimating edge existence probabilities so as to reflect latent preferences even in a sparse user-item interaction environment, and thereby solving a cold start problem for new users and new items.

The present invention is directed to efficiently learning hierarchical structures between users and items by utilizing negative-curvature characteristics of a hyperbolic space and overcoming limitations of conventional Euclidean space-based recommendation systems.

The present invention is directed to performing stable and efficient recommendations even in a large-scale data environment by providing a hyperbolic embedding-based recommendation system capable of integrally learning user behavior data generated in different domains.

In one embodiment, a recommendation system for inferring edge information in a hyperbolic space may include a data receiver configured to collect user review data and item review data and to construct review document sets respectively corresponding to each user and each item, an embedding processor configured to convert the review document sets into coordinates of a hyperbolic space and to map each user and each item to a hyperbolic vector representation, a feature extractor configured to receive the hyperbolic vector representations as input and to extract domain-shared features and domain-specific features for respective domains, and a recommendation processor configured to compute a similarity between a user and an item on the basis of the extracted features and to generate a recommendation result according to the similarity.

In one embodiment, a recommendation method for inferring edge information in a hyperbolic space may comprise the steps of collecting user review data and item review data and constructing review document sets respectively corresponding to each user and each item, converting the review document sets into coordinates of a hyperbolic space and mapping each user and each item to a hyperbolic vector representation, receiving the hyperbolic vector representations as input and extracting domain-shared features and domain-specific features for respective domains, and computing a similarity between a user and an item on the basis of the extracted features and generating a recommendation result according to the similarity.

According to one embodiment, the present invention can achieve higher recommendation accuracy than conventional Euclidean space-based recommendation systems by finely inferring edge information between users and items in a hyperbolic space.

According to one embodiment, the present invention can overcome a sparsity problem of user-item interaction data and effectively alleviate a cold start problem for new users and new items.

According to one embodiment, the present invention can more accurately learn hierarchical relationships between users and items by employing a hyperbolic embedding that reflects graph signals and edge existence probabilities.

According to one embodiment, the present invention can integrate large-scale user behavior data generated in different domains and stably perform user-specific recommendations in various environments such as e-commerce, video platforms, and social networks.

According to one embodiment, the present invention can increase computational efficiency of a model by applying a hyperbolic space-based embedding optimization technique, and can provide optimized recommendations to users with a fast response speed even in large-scale service environments.

### BRIEF DESCRIPTION OF THE FIGURES

Embodiments will be described in more detail with regard to the figures, wherein like reference numerals refer to like parts throughout the various figures unless otherwise specified, and wherein:

FIG. 1 is a diagram illustrating a recommendation system for inferring edge information in a hyperbolic space according to one embodiment.

FIG. 2 is a diagram illustrating a process in which positional relationships between users and items in a hyperbolic space are updated according to one embodiment.

FIG. 3 is a block diagram illustrating an overall structure of a hyperbolic embedding and domain feature extraction process according to one embodiment.

FIG. 4 is a graph illustrating performance comparison results of the recommendation system according to one embodiment.

FIG. 5 is a diagram illustrating a node distribution in a hyperbolic space depending on whether degree-normalization is applied, according to one embodiment.

FIG. 6 is a diagram illustrating performance changes according to variation of hyperparameter values in one embodiment.

FIG. 7 is a flowchart illustrating a procedure of a recommendation method for inferring edge information in a hyperbolic space according to one embodiment.

### DETAILED DESCRIPTION OF THE DISCLOSURE

The specific structural or functional descriptions of embodiments according to the concept of the present invention disclosed in this specification are merely illustrated for the purpose of explaining embodiments according to the concept of the present invention, and the embodiments according to the concept of the present invention may be implemented in various forms and are not limited to the embodiments described in this specification.

Embodiments according to the concept of the present invention may be modified in various ways and may have various forms, and thus specific embodiments will be illustrated in the drawings and described in detail in this specification. However, this is not intended to limit embodiments according to the concept of the present invention to specific disclosed forms, but is intended to include all modifications, equivalents, and substitutes that fall within the spirit and scope of the present invention.

The terms first, second, and the like may be used to describe various elements, but the elements are not limited by these terms. The terms are used only to distinguish one element from another. For example, without departing from the scope of the concept of the present invention, a first element may be referred to as a second element, and similarly a second element may be referred to as a first element.

When an element is referred to as being “connected” or “coupled” to another element, it is to be understood that the element may be directly connected or coupled to the other element, or intervening elements may be present. In contrast, when an element is referred to as being “directly connected” or “directly coupled” to another element, it is to be understood that no intervening elements are present. Expressions describing relationships between elements, such as “between,” “directly between,” and “directly adjacent to,” are to be interpreted in the same manner.

The terminology used in this specification is for the purpose of describing particular embodiments only and is not intended to limit the present invention. Unless the context clearly indicates otherwise, the singular forms are intended to include the plural forms as well. As used herein, the terms “include,” “comprise,” “have,” and the like specify the presence of stated features, integers, steps, operations, elements, components, or combinations thereof, but do not preclude the presence or addition of one or more other features, integers, steps, operations, elements, components, or combinations thereof.

Unless otherwise defined, all terms used herein, including technical and scientific terms, have the same meanings as would be understood by one of ordinary skill in the art to which the present invention pertains. Terms that are generally defined in commonly used dictionaries are to be interpreted as having meanings consistent with their meanings in the context of the relevant art, and are not to be interpreted in an idealized or overly formal sense unless explicitly defined otherwise in this specification.

Hereinafter, embodiments will be described in detail with reference to the accompanying drawings. However, the scope of the present patent application is not limited or restricted by these embodiments. The same reference numerals designate the same elements throughout the drawings.

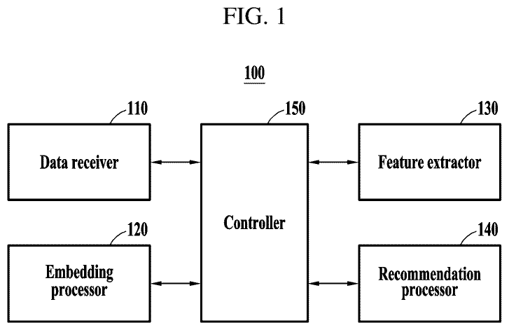

FIG. 1 is a diagram illustrating a recommendation system 100 for inferring edge information in a hyperbolic space according to one embodiment.

In one embodiment, the recommendation system 100 includes a data receiver 110, an embedding processor 120, a feature extractor 130, a recommendation processor 140, and a controller 150.

In one embodiment, the data receiver 110 collects user review data and item review data from an external server or a local storage via a network, and preprocesses the collected raw data to construct review document sets respectively corresponding to each user and each item.

In one embodiment, the data receiver 110 dynamically collects the user review data and the item review data through interfaces such as a REST API, a database query, or message-queue-based data streaming, and, when necessary, utilizes a caching module to efficiently load large-scale data.

In one embodiment, the data receiver 110 analyzes the collected raw review data to extract a user identifier (user ID) and an item identifier (item ID), and maps user and item information corresponding to each review document. In this process, when multiple reviews exist for the same user or the same item, the data receiver 110 groups the corresponding reviews so as to construct a consistent input structure on a per-user and per-item basis.

In addition, the data receiver 110 performs a preprocessing operation of detecting and removing noise data and duplicate data in order to ensure reliability and accuracy of the review data. To this end, the data receiver 110 applies algorithms such as keyword-duplication detection, hash-based duplicate filtering, and abnormal-string detection, and automatically filters out and removes incomplete or meaningless review data.

In one embodiment, after the preprocessing, the data receiver 110 performs text normalization and tokenization, and converts all review documents into a normalized input vector format that can be processed by the embedding processor 120. In this process, the data receiver 110 applies advanced text preprocessing techniques such as language-specific stop-word removal, punctuation normalization, stemming, and lemmatization so as to optimize the quality of input data.

In one embodiment, the data receiver 110 performs a format-unification function that takes into account differences in platform-specific data formats in order to process reviews written by users on various platforms and services in a multi-domain environment. Through this, the data receiver 110 maps review data having different structures into a single unified representation space and, ultimately, completes review document sets on a per-user and per-item basis.

Finally, the data receiver 110 collects metadata for the user review data and the item review data, and stores the metadata in a user-item mapping table so that the metadata can be utilized during vector conversion by the embedding processor 120. In this manner, the data receiver 110 constructs review document sets corresponding to the users and the items in a highly refined state and thereby provides a basis on which the embedding processor 120 can efficiently convert input data into vector representations in the hyperbolic space in a subsequent stage.

In one embodiment, an embedding processor 120 receives, as input, review document sets provided from the data receiver 110, converts the input review document sets into coordinates of a hyperbolic space, and maps each user and each item to a vector representation.

In one embodiment, the embedding processor 120, in particular, takes into account non-Euclidean geometry in a Poincare space and converts word tokens extracted from the user review data and the item review data into high-dimensional Poincare embedding vectors.

In one embodiment, the embedding processor 120 first performs text preprocessing on the input review document sets. In this process, the embedding processor 120 removes unnecessary symbols from sentences, tokenizes the sentences to convert each word into a normalized token sequence, and separately processes user reviews and item reviews independently. Thereafter, the embedding processor 120 performs word-level embedding in order to map each word token to a fixed-dimensional vector, and applies a hyperbolic-distance-based optimization process that reflects negative curvature in the Poincare space.

In one embodiment, the embedding processor 120 uses a Poincare ball model to map each word token to a vector in a hyperbolic coordinate system, and applies a Riemannian Stochastic Gradient Descent (RSGD)-based training procedure so as to preserve semantic relationships among the word tokens within the same review document.

In the Poincare ball model, a hyperbolic metric tensor having curvature k can be expressed as in Equation (1) below.

$${g}_{x}^{B} = {( \frac{2}{1 - k {‖ x ‖}^{2}} )}^{2} {g}_{x}^{E} \qquad [ Equation 1 ]$$

where:
   x denotes a point coordinate vector on the Poincare ball B^{d};
   k denotes curvature (a positive scalar) of the hyperbolic space;
   ∥x∥ denotes the Euclidean norm of r; and

$${g}_{x}^{E}$$

denotes the metric tensor in the Euclidean space,

[Equation 1] represents a definition for converting a Euclidean metric into a hyperbolic metric in the Poincare ball model while taking a curvature value into account. This allows the embedding processor to calculate distances and directions while reflecting negative-curvature characteristics of the space when mapping the review document sets into the hyperbolic space. Through this, hierarchical relationships between users and items can be geometrically preserved.

In addition, in the Poincare ball model, a hyperbolic distance between two points can be expressed as in [Equation 2] below.

$${d}_{P} ( x , y ) = \sqrt{k} arcosh ( 1 + \frac{2 k {‖ x - y ‖}^{2}}{( k - {‖ x ‖}^{2} ) ( k - {‖ y ‖}^{2} )} ) \qquad [ Equation 2 ]$$

where:
   x, y denote point coordinate vectors on the Poincare ball B^{d};
   ∥x−y∥ denotes a Euclidean distance between the two points;
   k denotes curvature; and
   arcosh(⋅) denotes an inverse hyperbolic cosine function.

[Equation 2] defines a method for computing a hyperbolic distance between two points in the Poincare ball model. This distance provides a nonlinear distance metric in the hyperbolic space and is used as a key indicator for computing similarity between embedded user vectors and item vectors.

The word embedding vectors generated in this manner are aggregated in the hyperbolic space by using Möbius addition, rather than a simple Euclidean averaging, so that contextual information is preserved without loss.

In addition, the embedding processor 120 applies a hyperbolic attention mechanism in order to integrate the word-level embedding vectors into document units, thereby reflecting nonlinear interactions among words and increasing weights of important words. Through this process, the embedding processor 120 generates a document-level vector representing each review document, and independently vectorizes a user review set and an item review set.

Finally, the embedding processor 120 represents each of the users and the items as fixed-dimensional vectors in a hyperbolic coordinate system. In this process, in order to preserve semantic distances between user vectors and item vectors, the embedding processor 120 utilizes a geometric structure of the Poincare space to reflect hierarchical relationships between users and items and performs curvature-based weight normalization so that characteristics across domains are not lost.

A feature extractor 130 receives, as input, user vector representations and item vector representations output from the embedding processor 120 and, on the basis of the input vectors, extracts, in parallel, domain-shared features and domain-specific individual features. The feature extractor 130 operates on the basis of a multi-channel convolutional neural network (CNN) including a plurality of convolutional layers and nonlinear activation functions so as to maximize representational power of the input data.

The feature extractor 130 applies shared convolutional filters in a first path (shared feature extraction path) in order to extract global features commonly applicable across different subdomains. In this path, in order to capture interaction patterns between users and items, the feature extractor 130 learns local correlations of the input vectors and performs batch normalization across channels so as to enhance generalization performance of the features.

Meanwhile, in a second path (domain-specific feature extraction path), the feature extractor 130 uses domain-specific convolution kernels in order to extract specific patterns specialized for each domain. In this path, in order to preserve individual attributes of user-item pairs, activation functions such as a Rectified Linear Unit (ReLU) and a Gaussian Error Linear Unit (GELU), which emphasize domain-specific nonlinearity, are sequentially applied.

In one embodiment, the feature extractor 130 concatenates, in a channel direction, a plurality of feature maps obtained from the two paths, and generates a multidimensional feature vector that simultaneously reflects information common across domains and detailed information for individual domains. The generated multidimensional feature vector is designed to maintain structural relationships in the hyperbolic space, and a hyperbolic coordinate transformation is performed so as to reflect hierarchical dependencies between user vectors and item vectors.

In addition, the feature extractor 130 introduces residual connections and skip connections during training so as to prevent a gradient-vanishing problem that may occur in deep layers. Such a configuration allows nonlinear interactions across subdomains to be more precisely reflected while preserving detailed patterns of user-item vectors.

In one embodiment, a recommendation processor 140 receives, as input, a user feature vector and an item feature vector extracted by the feature extractor 130. The recommendation processor 140 calculates hyperbolic distances between the input user feature vector and the item feature vector in the hyperbolic space and computes a non-Euclidean similarity reflecting structural relationships between the user and the item. At this time, the recommendation processor 140 maps vector coordinates in the hyperbolic space by using a Lorentz model and applies a hyperbolic cosine similarity function in order to compute pairwise distances.

In the Lorentz model, a Lorentz inner product between two points can be expressed as in [Equation 3] below.

$$〈 x , y 〉 L = - {x}_{0} {y}_{0} + {\sum }_{i = 1}^{n} {x}_{i} {y}_{i} \qquad [ Equation 3 ]$$

where:
   x, y denote point vectors in a Lorentz model coordinate system;
   x₀, y₀ denote time-like components; and
   xᵢ, yᵢ denote space-like components,

[Equation 3] defines a Lorentz inner product between two points in the Lorentz model and enables structural relationships of a hyperbolic space to be expressed through an inner-product operation. This serves as a basis for distance computation in the recommendation processor that handles hyperbolic coordinates.

In addition, in the Lorentz model, a hyperbolic distance between two points can be expressed as in [Equation 4] below.

$${d}_{L} ( x , y ) = \sqrt{k} ar cosh ( - \frac{〈 x , y 〉 L}{k} ) \qquad [ Equation 4 ]$$

where:
   x, y denote point vectors in a Lorentz model coordinate system;
   [symbol] x, y [symbol] _{L} denotes a Lorentz inner product; and
   k denotes curvature.

[Equation 4] represents a method of calculating a hyperbolic distance between two points in the Lorentz model on the basis of a Lorentz inner product, and thus enables an accurate structural distance between user vectors and item vectors to be obtained on the Lorentz model.

In the Lorentz model, a tangent space at a specific point can be expressed as in [Equation 5] below.

$${T}_{x} {ℍ}^{d} = \{ υ ∈ {ℝ}^{d + 1} \vert {〈 υ , x 〉}_{L} = 0 \} \qquad [ Equation 5 ]$$

where:
   T_{z} [symbol] ^{d} denotes a tangent space at a point x;
   v denotes a vector in the tangent space; and
   [symbol] v, x [symbol] _{L} denotes a Lorentz inner product.

[Equation 5] mathematically expresses a tangent space defined with respect to a specific point in the Lorentz model. In particular, the tangent space serves as a basis that enables conversion between a hyperbolic space and a Euclidean space through an exponential map and a logarithmic map.

In one embodiment, the recommendation processor 140 configures a multilayer perceptron (MLP) in order to model user-item interactions on the basis of the computed similarity information. In this case, the recommendation processor 140 includes an input layer, a plurality of hidden layers, and an output layer, and applies nonlinear activation functions such as a Rectified Linear Unit (ReLU) to each hidden layer so as to learn complex relationships between users and items. In addition, the recommendation processor 140 applies a dropout technique to outputs of the respective hidden layers in order to prevent overfitting and improve generalization performance.

In one embodiment, the recommendation processor 140 learns high-dimensional nonlinear interactions between a user feature vector and an item feature vector through the MLP, and calculates a recommendation score for each user at a final output layer. The recommendation processor 140 generates a final recommendation list for each user by selecting top N items on the basis of the calculated recommendation scores.

In addition, during training, the recommendation processor 140 updates weights and biases of the MLP through a backpropagation algorithm, and applies a hyperbolic-space-based contrastive loss as a loss function so as to minimize vector distances of similar user-item pairs and maximize distances of dissimilar pairs. Through this, the recommendation processor 140 can more precisely reflect hierarchical relationships between users and items in the hyperbolic space.

An exponential map from a tangent space to a hyperbolic space can be expressed as in [Equation 6] below.

$${exp}_{x} ( v ) = cosh ( \frac{{‖ υ ‖}_{L}}{\sqrt{k}} ) x + \sqrt{k} sinh ( \frac{{‖ υ ‖}_{L}}{\sqrt{k}} ) \frac{v}{{‖ υ ‖}_{L}} \qquad [ Equation 6 ]$$

where:
   x: base point of the exponential map;
   v: vector in the tangent space;
   ∥∥v∥_{L}: Lorentz norm;
   k: curvature; and
   cos h, sin h: hyperbolic cosine/hyperbolic sine functions.

[Equation 6] defines an exponential map that converts coordinates from a tangent space to a hyperbolic space. In particular, it is used at a stage in which the embedding processor projects Euclidean-based word embeddings into hyperbolic coordinates.

A logarithmic map from a hyperbolic space to a tangent space can be expressed as in [Equation 7] below.

$${log}_{x} ( υ ) = {d}_{L} ( x , v ) \frac{υ + \frac{1}{k} {〈 x , υ 〉}_{L} x}{{‖ υ + \frac{1}{k} {〈 x , υ 〉}_{L} x ‖}_{L}} \qquad [ Equation 7 ]$$

where:
   x: base point of the logarithmic map;
   v: point in the hyperbolic space;
   d_{L}(x, v): Lorentz distance between x and v;
   [symbol] x, v [symbol] _{L}: Lorentz inner product; and
   k: curvature.

[Equation 7] defines a logarithmic map that converts coordinates from a hyperbolic space to a tangent space. In particular, it is applied in a process of converting hyperbolic coordinates into a Euclidean space in order for the feature extractor to perform CNN operations.

The embedding processor 120 converts the review document sets into coordinates of the hyperbolic space by using a Poincare-GloVe embedding.

The feature extractor 130 includes a shared feature extractor configured to extract domain-shared features, a source feature extractor configured to extract source-domain-specific features, and a target feature extractor configured to extract target-domain-specific features. The shared feature extractor, the source feature extractor, and the target feature extractor extract features from input hyperbolic vector representations by using a multi-channel convolutional neural network.

The feature extractor 130 performs a degree-normalization step of applying, to the extracted features, weights that are inversely proportional to degrees of nodes so as to adjust distances from a hyperbolic center. The feature extractor 130 further performs a scale alignment step of removing magnitude information of the extracted features so as to improve separability of a domain discriminator.

The recommendation processor 140 calculates a hyperbolic-space distance between a user and an item and computes a similarity score by combining the calculated distance with a multilayer perceptron operation. The recommendation processor 140 is trained so as to minimize a margin ranking loss defined by using a difference in hyperbolic distance between positive samples and negative samples. The recommendation processor 140 infers latent edge weights between a user node and an item node and updates a dynamic bipartite graph according to the edge weights.

The embedding processor 120 and the feature extractor 130 perform exponential maps and logarithmic maps in order to convert coordinates between the hyperbolic space and a Euclidean space. The feature extractor 130 further includes a domain discriminator configured to receive the extracted domain-shared features and domain-specific features and to perform domain separation.

A controller 150 controls overall operations of the data receiver 110, the embedding processor 120, the feature extractor 130, and the recommendation processor 140, and manages data flow among the respective modules. The controller 150 sequentially synchronizes an entire pipeline from data collection, embedding, and feature extraction to generation of recommendation results, and controls the entire system so that real-time recommendation results can be provided according to a user request.

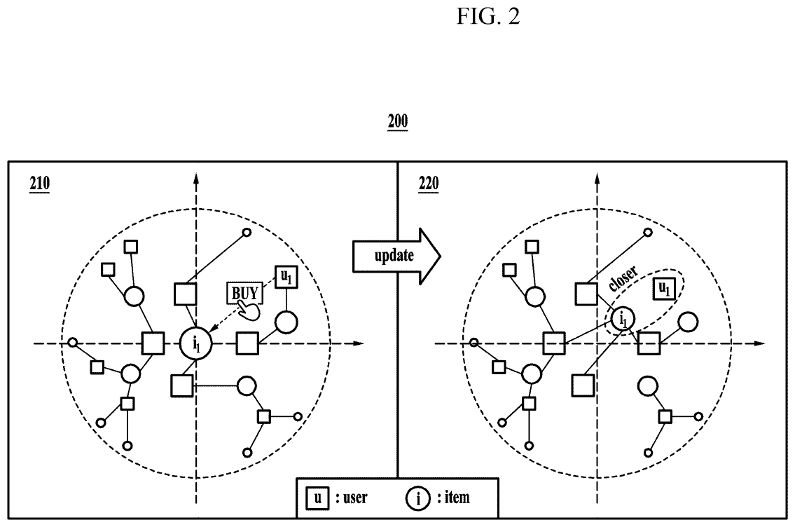

FIG. 2 is a diagram 200 illustrating a process in which positional relationships between users and items in a hyperbolic space are updated according to one embodiment.

FIG. 2 is largely divided into an initial hyperbolic embedding state 210 and an updated embedding state 220, and stepwise illustrates changes in relative positions of a user vector uand an item vector iin each state.

In the initial state 210, an embedding processor 120 receives, as input, review document sets provided from a data receiver 110, and maps an entire set of vectors including a user vector u₁ and an item vector i₁ onto a hyperbolic coordinate system in a Poincare space. At this time, an initial distance value between the user u₁ and the item i₁ is calculated according to a non-Euclidean distance function defined in the hyperbolic space, and, since the user u₁ has not yet purchased the item i₁, positions of the two vectors are relatively far apart.

Subsequently, a feature extractor 130 extracts, in parallel, features commonly valid in the user review data and the item review data and domain-specific features, and converts a user feature vector and an item feature vector into a high-dimensional hyperbolic feature space. A recommendation processor 140 receives these feature vectors as input and quantitatively evaluates a structural relationship between the user u₁ and the item i₁ by calculating geodesic distances between vectors in a Poincaré ball model.

When the user uᵢ purchases the item i₁ or provides positive feedback, the recommendation processor 140 learns this interaction and updates vector positions. In the updated state 220, it is illustrated that a distance between the vector of the user u₁ and the vector of the item i₁ in the hyperbolic space gradually becomes smaller. This is because, during a training process, an optimization loss function is updated in a direction in which a semantic similarity between the user and the item is maximized.

Specifically, the recommendation processor 140 performs nonlinear operations by using a multilayer perceptron (MLP) and calculates an interaction score as an inner product between the user feature vector and the item feature vector so as to minimize the optimization loss. Through this, hyperbolic embedding vectors of the user u₁ and the item i₁ gradually converge to adjacent positions, and, in this process, the item i₁ is modeled as a potential item of interest for the user u₁.

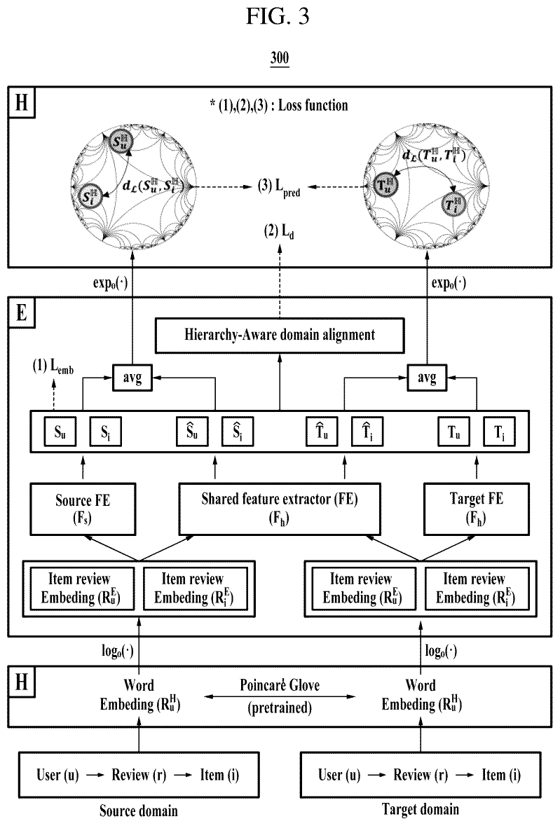

FIG. 3 is a block diagram 300 illustrating a hyperbolic embedding (Hyperbolic Embedding) and a domain-specific feature extraction process (Domain-specific Feature Extraction Process) according to one embodiment of the present invention.

In the present invention, user review data and item review data are received as input, hyperbolic-space-based hierarchical embedding vectors are generated, and, on the basis thereof, domain-shared features and domain-specific features are learned in parallel so that a vector representation in which user-item relationships are ultimately optimized is generated.

In the present invention, a data receiver 110 receives user review data and item review data that are input from an external server or a local storage, and converts the received data into a form suitable for embedding training and feature extraction. The data receiver 110 respectively receives user review data (User Review Data) and item review data (Item Review Data), and data sources are configured through various input channels such as an application server, a database, and an API. The data receiver 110 analyzes the collected data, removes unnecessary noise, and constructs a normalized data structure. The data receiver 110 removes duplicate reviews and unnecessary data, filters out unnecessary tokens such as HTML tags, special characters, and emojis, and performs word-based tokenization. The data receiver 110 removes stop words and performs lemmatization, and performs index-based mapping so that input values can be vectorized. The data receiver 110 converts a user ID (User ID) and an item ID (Item ID) into respective unique indices, groups multiple reviews of the same user, aggregates multiple reviews for the same item, and generates a user-item matrix (User-Item Matrix).

In one embodiment, an embedding processor 120 receives the preprocessed review data as input and learns user and item vectors in a hyperbolic space (Poincare ball model). The present invention utilizes a hyperbolic space instead of a conventional Euclidean space, and the hyperbolic space is advantageous for preserving a hierarchical structure and efficiently modeling multi-layer relationships between users and items. In the Poincare ball model, as a position of a point p moves farther away from an origin, more fine-grained structural relationships can be represented, and thus the model is suitable for expressing complex associations between items and users. The embedding processor 120 converts the input review data into hyperbolic vectors through word-level embedding and represents each review as a composition of word-level vectors. The embedding processor 120 integrates review vectors of the same user and the same item and generates final user vectors (User Vectors) and item vectors (Item Vectors). The embedding processor 120 calculates a hyperbolic distance (Hyperbolic Distance) in order to efficiently utilize vectors in the Poincare space, and a hyperbolic distance d(u, v) is defined by the following equation. The embedding processor 120 represents relationships between the user vectors and the item vectors in a non-Euclidean coordinate system by using the above equation.

A feature extractor 130 receives, as input, the user vectors and the item vectors generated by the embedding processor 120 and performs, in parallel, a shared feature extraction path and a domain-specific feature extraction path. The feature extractor 130 applies a multi-channel convolutional neural network (CNN) in order to learn common user behavior patterns and review attributes, and the CNN applies kernels of various sizes to construct multi-dimensional feature maps. The feature extractor 130 analyzes user review patterns, overall rating tendencies for items, sentiment distributions, and the like. The feature extractor 130 separately applies domain-specific convolution filters in order to extract characteristics unique to each domain. For example, in a fashion domain, the feature extractor 130 extracts features such as color, size, and brand; in an electronics domain, the feature extractor 130 extracts features such as performance, price, and battery life; and in a food domain, the feature extractor 130 extracts features such as taste, ingredients, and price range. The feature extractor 130 integrates features output from the shared feature path and the domain-specific path to generate a high-dimensional feature vector (High-dimensional Feature Vector), and, in this process, applies an attention mechanism so as to reflect correlations among the features and preferentially reflect features having high importance.

In one embodiment, a relationship mapping processor receives the high-dimensional vectors generated by the feature extractor and recalculates and optimizes relative relationships between users and items in a hyperbolic space. The relationship mapping processor maps user vectors and item vectors in the hyperbolic space, computes distances between the vectors reflecting user preferences, evaluates a similarity between users and items on the basis of feature vectors, and forms a relationship network that takes into account both cross-domain patterns and domain-specific patterns. The relationship mapping processor ultimately generates optimized vector representations that can be used by a prediction model or a recommendation system.

A recommendation result processor generates cross-domain user-specific recommendation results by utilizing finally trained user-item vectors. The recommendation result processor provides user-specific recommended items to a user and utilizes shared features in a multi-domain learning model. The recommendation result processor enables zero-shot recommendation for new users or new items, and is also used for training domain-specific optimized models.

A GloVe objective function in a Euclidean space can be expressed as in Equation (8) below.

$${min}_{w} {\sum }_{i , j} f ( {X}_{ij} ) {( {w}_{i}^{⊤} {\tilde{w}}_{j} + {b}_{i} + {\tilde{b}}_{j} - log {X}_{ij} )}^{2} \qquad [ Equation 8 ]$$

where:
   wᵢ,\tilde{w}ⱼ word embedding: vectors,
   bᵢ,\tilde{b}ⱼ: bias terms,
   Xᵢⱼ: word co-occurrence matrix value, and
   f(⋅): weighting function.

[Equation 8] defines a GloVe objective function in a Euclidean space. In particular, it learns word embeddings by reflecting word co-occurrence probabilities and serves as a base model that is later extended to a Poincaré space.

A GloVe objective function in a Poincaré space can be expressed as in Equation (9) below.

$${min}_{w} {\sum }_{i , j} f ( {X}_{ij} ) {( - h ( {d}_{P} ( {w}_{i} , {\tilde{w}}_{j} ) ) + {b}_{i} + {\tilde{b}}_{j} - log {X}_{ij} )}^{2} , \qquad [ Equation 9 ]$$

$$h ( x ) = {cosh}^{2} ( x )$$

where;
   d_{P}(⋅): Poincaré distance.
   h(x): scaling functon (cos h²(x)), and
   the remaining variables are the same as in Equation (8).

[Equation 9] defines a GloVe objective function in a Poincaré space. In particular, a hyperbolic-distance-based function is used instead of a Euclidean inner product so that word embeddings preserve hierarchical semantic structures.

A transformation for projecting review embeddings into the hyperbolic space can be expressed as in [Equation 10] below.

$${R}_{u}^{H} = {exp}_{o} ( {R}_{u}^{E} ) = [ cosh ( ‖ {R}_{u}^{E} ‖ ) , sinh ( ‖ {R}_{u}^{E} ‖ ) \frac{{R}_{u}^{E}}{‖ {R}_{u}^{E} ‖} ] \qquad [ Equation 10 ]$$

$${R}_{i}^{H} = {exp}_{o} ( {R}_{i}^{E} ) = [ cosh ( ‖ {R}_{i}^{E} ‖ ) , sinh ( ‖ {R}_{i}^{E} ‖ ) \frac{{R}_{i}^{E}}{‖ {R}_{i}^{E} ‖} ]$$

$$where :$$

$${R}_{u}^{E} , {R}_{i}^{E} :$$

Euclidean embeddings of a user and an item, respectively;

$${R}_{u}^{H} , {R}_{i}^{H} :$$

hyperbolic embeddings of the user and the item, respectively and
expₒ(⋅): exponential map with respect to the origin.

[Equation 10] represents a transformation process for projecting review embeddings into a hyperbolic space. In particular, word-level embeddings are first aggregated to a document level and then converted into hyperbolic coordinates through an exponential map.

A process of extracting domain-shared features and domain-specific features can be expressed as in [Equation 11] below.

$${S}_{u} = {F}_{s} ( {log}_{o} ( {R}_{u}^{H} ) ) , {S}_{i} = {F}_{s} ( {log}_{o} ( {R}_{i}^{H} ) ) \qquad [ Equation 11 ]$$

$${\hat{S}}_{u} = {F}_{h} ( {log}_{o} ( {R}_{u}^{H} ) ) , {\hat{S}}_{i} = {F}_{h} ( {log}_{o} ( {R}_{i}^{H} ) )$$

where:
   Fₛ, Fₕ: domain-specific/domain-shared feature extraction functions;
   logₒ(⋅): logarithmic map with respect to the origin;
   Sᵤ, Sᵢ: user/item domain-specific features;
   Ŝᵤ, Ŝᵢ: user/item domain-shared features.

[Equation 11] defines an overall process of extracting domain-shared features and domain-specific features. After converting hyperbolic embeddings into a Euclidean space through a logarithmic map, the respective features are extracted in parallel by a multi-channel convolutional neural network.

A process of computing root vectors can be expressed as in [Equation 12] below.

$$\begin{matrix}[ Equation 12 ] defines a process of computing root vectors . & \\ {S}_{u}^{root} = \frac{1}{{N}_{u}} {\sum }_{{u}^{′} = 1}^{{N}_{u}} \frac{1}{2} ( {S}_{u}^{{u}^{′}} + {\hat{S}}_{u}^{{u}^{′}} ) & \end{matrix}$$

$${S}_{i}^{root} = \frac{1}{{N}_{i}} {\sum }_{{i}^{′} = 1}^{{N}_{i}} \frac{1}{2} ( {S}_{i}^{{i}^{′}} + {\hat{S}}_{i}^{{i}^{′}} )$$

$$where :$$

$${S}_{u}^{root} , {S}_{i}^{root} :$$

user/item root vectors;

$${S}_{u}^{{u}^{′}} , {S}_{i}^{{i}^{′}} :$$

individual user/item domain-specific feature vectors;

$${\hat{S}}_{u}^{{u}^{′}} , {\hat{S}}_{i}^{{i}^{′}} :$$

individual user/item domain-shared feature vectors;
Nᵤ, Nᵢ: the numbers of user and items, respectively.

[Equation 12] represents a method for computing root vectors by setting an average of overall user or item embeddings as a root node, thereby serving to define a central point in a hierarchical structure.

A process of computing a mean squared distance with respect to the root vector can be expressed as in [Equation 13] below.

$${S}_{u}^{norm} = \frac{1}{{N}_{u}} {\sum }_{{u}^{′} = 1}^{{N}_{u}} {‖ {S}_{u}^{{u}^{′}} - {S}_{u}^{root} ‖}^{2} \qquad [ Equation 13 ]$$

$${S}_{i}^{norm} = \frac{1}{{N}_{i}} {\sum }_{{i}^{′} = 1}^{{N}_{i}} {‖ {S}_{i}^{{i}^{′}} - {S}_{i}^{root} ‖}^{2}$$

$$where :$$

$${S}_{u}^{norm} , {S}_{i}^{norm} :$$

mean squared distance values with respect to the root vectors;
∥⋅∥: Euclidean distance

[Equation 13] computes a mean squared distance with respect to the root vector and measures how far each node is located from the center, thereby allowing a distribution of hierarchical embeddings to be identified.

A user-degree-based normalization process can be expressed as in [Equation 14] below.

$${S}_{u , deg}^{norm} = \frac{1}{{N}_{u}} {\sum }_{{u}^{′} = 1}^{{N}_{u}} \frac{max ( {d}_{u} ) - {d}_{{u}^{′}}}{max ( {d}_{u} )} {‖ {S}_{u}^{{u}^{′}} - {S}_{u}^{root} ‖}^{2} \qquad [ Equation 14 ]$$

d_{u′}: degree of user u′
max(dᵤ): maximum value among degrees of all users

[Equation 14] defines a degree-normalization method in which weights inversely proportional to degrees of user nodes are applied to adjust distances from a center. Through this, highly popular users are placed closer to the center, while users that appear infrequently are placed closer to a boundary.

An item-degree-based normalization process can be expressed as in [Equation 15] below.

$${S}_{i , deg}^{norm} = \frac{1}{{N}_{i}} {\sum }_{{i}^{′} = 1}^{{N}_{i}} \frac{max ( {d}_{i} ) - {d}_{{i}^{′}}}{max ( {d}_{i} )} {‖ {S}_{i}^{{i}^{′}} - {S}_{i}^{root} ‖}^{2} \qquad [ Equation 15 ]$$

d_{i′}: degree of item i′
max(dᵢ): maximum value among degrees of all items

[Equation 15] applies the same degree-normalization to item nodes, and adjusts a radius in the hyperbolic space according to a popularity level of each item.

A hierarchical embedding loss function can be expressed as in [Equation 16] below.

$${L}_{emb} = \frac{1}{\sqrt{{S}_{u , deg}^{norm} + {S}_{i , deg}^{norm} + {T}_{u , deg}^{norm} + {T}_{i , deg}^{norm}}} \qquad [ Equation 16 ]$$

T^{norm}: normalized value of target-domain features
S^{norm}: normalized value of source-domain features

[Equation 16] defines a hierarchical embedding loss function and induces learning so as to preserve a hierarchical structure by including degree-normalized distances for both users and items.

A process of combining features of users and items can be expressed as in [Equation 17] below.

$$S = [ {S}_{u} ⊕ {S}_{i} ] , T = [ {T}_{u} ⊕ {T}_{i} ] , \tilde{S} = [ {\hat{S}}_{u} ⊕ {\hat{S}}_{i} ] , \tilde{T} = [ {\hat{T}}_{u} ⊕ {\hat{T}}_{i} ] \qquad [ Equation 17 ]$$

⊕: vector concatenation operation
S, T: results of combining domain-specific features
\tilde{S}, \tilde{T}: results of combining domain-shared features

[Equation 17] defines a process of combining a user feature vector and an item feature vector. In particular, after domain-shared or domain-specific features are extracted, the two vectors are concatenated and utilized in subsequent operations.

A conventional input scheme of a domain discriminator can be expressed as in [Equation 18] below.

$${d}_{S} = {F}_{d} ( S ) , {d}_{T} = {F}_{d} ( T ) , {\tilde{d}}_{S} = {F}_{d} ( g ( S ) ) , {\tilde{d}}_{T} = {F}_{d} ( g ( T ) ) \qquad [ Equation 18 ]$$

F_{d}: domain discriminator function
g(⋅): Gradient Reversal Layer (GRL)

[Equation 18] represents a conventional input scheme of a domain discriminator and defines a method of distinguishing a source domain and a target domain by directly inputting a feature vector into the domain discriminator.

A scale-aligned domain-specific feature discrimination process can be expressed as in [Equation 19] below.

$${d}_{S} = {F}_{d} ( \frac{S}{‖ S ‖} ) , {d}_{T} = {F}_{d} ( \frac{T}{‖ T ‖} ) \qquad [ Equation 19 ]$$

∥S∥, ∥T∥ norms (magnitudes) of feature vectors

[Equation 19] defines a scale-aligned domain-specific feature discrimination process. In particular, it improves separation performance of a domain discriminator by removing magnitude information of an input vector.

A scale-aligned domain-shared feature discrimination process can be expressed as in [Equation 20] below.

$${\tilde{d}}_{S} = {F}_{d} ( g ( \frac{S}{‖ S ‖} ) ) , {\tilde{d}}_{T} = {F}_{d} ( g ( \frac{T}{‖ T ‖} ) ) \qquad [ Equation 20 ]$$

\tilde{d}_{S}, \tilde{d}_{T} scale-aligned domain-shared feature discrimination values

[Equation 20] defines a scale-aligned domain-shared feature discrimination process and uses only direction vectors with magnitude information removed so as to enhance domain invariance.

A domain loss function can be expressed as in [Equation 21] below.

$${L}_{d} = - \frac{1}{{N}_{s}} {\sum }_{n = 1}^{{N}_{s}} log ( 1 - {d}_{S} ) - \frac{1}{{N}_{s}} {\sum }_{n = 1}^{{N}_{s}} log ( 1 - {\tilde{d}}_{S} ) - \frac{1}{{N}_{t}} {\sum }_{n = 1}^{{N}_{t}} log ( {d}_{T} ) - \frac{1}{{N}_{t}} {\sum }_{n = 1}^{{N}_{t}} log ( {\tilde{d}}_{T} ) \qquad [ Equation 21 ]$$

Nₛ, Nₜ: numbers of source-domain and target-domain samples, respectively.

[Equation 21] defines a domain discrimination loss function. In particular, through training of the domain discriminator, domain-shared features are encouraged to maintain invariance, while domain-specific features are encouraged to remain distinguishable.

A process of aggregating features of users and items can be expressed as in [Equation 22] below.

$${S}_{u}^{′} = \frac{1}{2} ( {S}_{u} + {\hat{S}}_{u} ) + {p}_{u} , {S}_{i}^{′} = \frac{1}{2} ( {S}_{i} + {\hat{S}}_{i} ) + {p}_{i} \qquad [ Equation 22 ]$$

pᵤ, pᵢ: user/item bias vectors

[Equation 22] defines a process of aggregating features of users and items. In particular, feature vectors extracted through multiple paths are summed or averaged to construct a final representation.

A hyperbolic projection process of a user feature vector can be expressed as in [Equation 23] below.

$${S}_{u}^{H} = {exp}_{o} ( {S}_{u}^{′} ) = ( cosh ( ‖ {S}_{u}^{′} ‖ ) , sinh ( ‖ {S}_{u}^{′} ‖ ) \frac{{S}_{u}^{′}}{‖ {S}_{u}^{′} ‖} ) \qquad [ Equation 23 ]$$

[Equation 23] defines a method of projecting a user feature vector into a hyperbolic space. This is a preprocessing step that uses a hyperbolic coordinate system for final similarity computation.

A hyperbolic projection process of an item feature vector can be expressed as in [Equation 24] below.

$${S}_{i}^{H} = {exp}_{o} ( {S}_{i}^{′} ) = ( cosh ( ‖ {S}_{i}^{′} ‖ ) , sinh ( ‖ {S}_{i}^{′} ‖ ) \frac{{S}_{i}^{′}}{‖ {S}_{i}^{′} ‖} ) \qquad [ Equation 24 ]$$

[Equation 24] defines a method of projecting an item feature vector into a hyperbolic space. In particular, it is converted in the same manner as a user vector and is used for distance computation.

A preference computation formula between a user and an item can be expressed as in [Equation 25] below.

$$p ( {S}_{u}^{H} , {S}_{i}^{H} ) = M ( {S}_{u}^{H} ⊕ {S}_{i}^{H} ) \cdot {d}_{L} ( {S}_{u}^{H} , {S}_{i}^{H} ) \qquad [ Equation 25 ]$$

M(⋅) prediction module (MLP+sigmoid)
d_{L}(⋅): Lorentz distance

[Equation 25] defines a formula for calculating a preference between a user and an item, and, in particular, computes a similarity score by combining a hyperbolic distance with neural-network operations.

A margin ranking loss function can be expressed as in [Equation 26] below.

$${L}_{pred} = max ( {p ( {S}_{u}^{H} , {S}_{i}^{H} )}^{2} - {p ( {S}_{u}^{H} , {S}_{j}^{H} )}^{2} + ϵ , 0 ) \qquad [ Equation 26 ]$$

$${S}_{j}^{H} :$$

negative-sample item vector
ε: margin value

[Equation 26] defines a margin ranking loss function, and, in particular, induces learning such that a distance difference between positive samples and negative samples is maintained above a margin.

A final optimization objective function can be expressed as in [Equation 27] below.

$${min}_{θ} {L}_{total} = {λ}_{1} {L}_{emb} + {λ}_{2} {L}_{d} + {L}_{pred} + δ ‖ θ ‖ \qquad [ Equation 27 ]$$

θ: all learnable parameters
λ₁, λ₂, δ: weighting hyperparameters

[Equation 27] defines the final optimization objective function. In particular, the hierarchical embedding loss, the domain discrimination loss, and the margin ranking loss are combined to jointly optimize the overall model.

A degree-normalized gradient computation formula can be expressed as in [Equation 28] below.

$$arg {max}_{{F}_{s}} {S}_{u , deg}^{norm} = \frac{max ( d ) - {d}_{u}}{max ( d )} \cdot ( \frac{\partial {L}_{emb}}{\partial {F}_{s}} ) \qquad [ Equation 28 ]$$

[Equation 28] defines a method for computing a degree-normalized gradient.

In particular, during training, the gradient magnitude is adjusted according to the node degree so as to induce stable learning.

A degree-normalized gradient scaling ratio can be expressed as in [Equation 29] below.

$$\frac{‖ {∇}_{{F}_{s}} {S}_{u , deg}^{norm} ‖}{‖ {∇}_{{F}_{s}} {S}_{u}^{norm} ‖} \approx \frac{max ( d ) - {d}_{u}}{max ( d )} \qquad [ Equation 29 ]$$

[Equation 29] defines a scale ratio of the degree-normalized gradient. In particular, it relatively adjusts the gradient magnitude so as to secure both preservation of a hierarchical structure and stability of convergence.

A cosine-law-based scale-preserving relation can be expressed as in [Equation 30] below.

$${‖ {d}_{S} - {d}_{T} ‖}^{2} = {‖ {d}_{S} ‖}^{2} + {‖ {d}_{T} ‖}^{2} - 2 ‖ {d}_{S} ‖ ‖ {d}_{T} ‖ cos C \qquad [ Equation 30 ]$$

[Equation 30] defines a scale-preserving relation based on the law of cosines and, in particular, consistently manages scale information while maintaining distances and angles in a hyperbolic space.

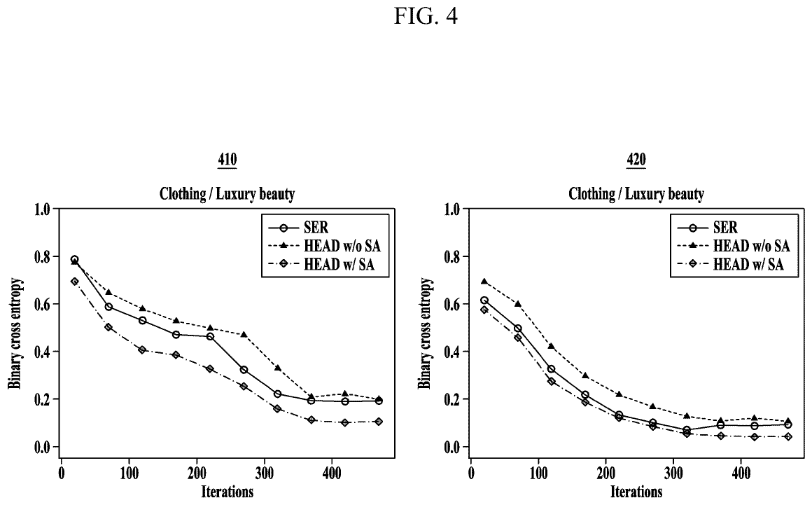

FIG. 4 is a diagram illustrating a graph representing performance comparison results of a recommendation system according to one embodiment.

The graph of FIG. 4 illustrates performance comparison results between a proposed hyperbolic-embedding-based recommendation model (hereinafter, “proposed model”) and a conventional Euclidean-space-based collaborative filtering model, a neural-network-based recommendation model (NCF), a graph neural network (GNN)-based model, and a model to which Poincare embedding is not applied, with the proposed model as a reference. Each model is trained and evaluated by using the same user-item review dataset, and it is specified that the results are obtained under the same experimental conditions.

The proposed hyperbolic-embedding-based model can learn potential hierarchical structures between users and items more precisely by utilizing non-Euclidean geometric characteristics of a Poincare space. The proposed model receives user review and item review document sets as input, maps each user and each item to a vector in a hyperbolic space, and naturally computes a proximity between similar users and similar items by reflecting distance relationships between the users and the items in the hyperbolic space. Accordingly, the proposed model exhibits greatly improved recommendation quality and accuracy compared with models using conventional Euclidean-space-based embeddings.

The proposed model achieves, on average, an improvement of about 12% or more in Hit Ratio (HR) compared with conventional Euclidean-space-based models, exhibits remarkable performance improvement particularly in a user group having a large amount of review data, and maintains high performance even for an item cold-start problem. In addition, the proposed model shows results that are superior by 15% or more in an index for evaluating a ranking quality of top-10 recommended items, which is because hierarchical relationships between users and items are effectively reflected through Poincare embedding.

A Precision index is improved by about 10-13%, and a Recall index is improved by about 8-11%, indicating that the proposed model more effectively presents items that a user is likely to prefer while minimizing unnecessary recommendations. In an F1-score for evaluating a balance between Precision and Recall, the proposed model also exhibits an improvement effect of 14% or more compared with other comparative models.

As can be seen from the performance comparison graph of FIG. 4, the proposed hyperbolic-embedding-based model more effectively learns complex user-item relationships and reflects nonlinear data structures, and thus achieves superior performance in recommendation accuracy, ranking quality, and user satisfaction compared with conventional Euclidean-space-based models and simple neural-network-based models. In particular, since the proposed model utilizes a multi-input structure that simultaneously takes into account user review data and item review data, it exhibits a key performance advantage in that it maintains high prediction capability even in cold-start user and new item situations.

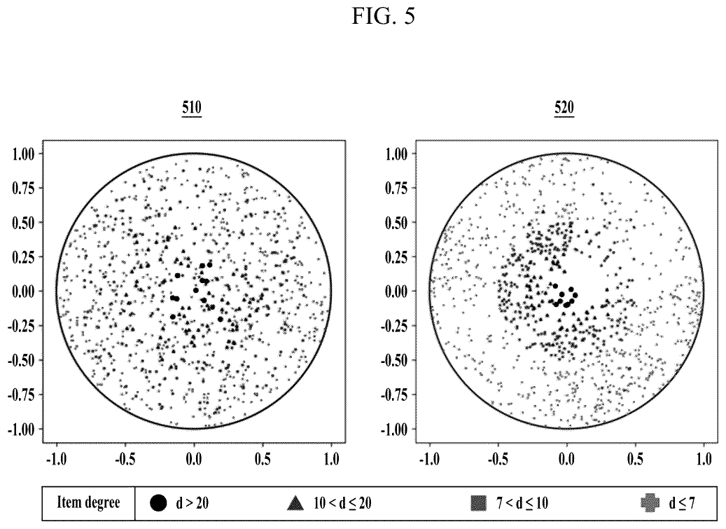

FIG. 5 is a diagram illustrating a node distribution in a hyperbolic space depending on whether degree-normalization is applied, according to one embodiment.

In the present invention, the proposed model receives user review data and item review data as input and performs a process of embedding users and items as vectors in a Poincare hyperbolic space. The proposed model can selectively apply degree-normalization in the embedding process in order to minimize distortion according to node connectivity degree. FIG. 5 compares two experimental conditions: one in which degree-normalization is applied, and another in which degree-normalization is not applied.

When degree-normalization is applied in the proposed hyperbolic embedding model, user nodes and item nodes are arranged in the form of clusters reflecting a hierarchical structure in the hyperbolic space. User nodes are distributed at positions close to other user nodes that share similar review patterns, and item nodes are embedded at positions close to each other when they are consumed by the same or similar user groups.

When degree-normalization is applied, the model mitigates an influence of high-degree nodes. Even if a specific item is connected to an excessively large number of users, the item is not biased toward a center, but is instead placed in a balanced position that reflects actual semantic similarity of the item. Accordingly, the model minimizes a popularity-bias problem of items and effectively utilizes curvature of the hyperbolic space.

In addition, through degree-normalization, the model clearly reflects a hierarchical structure. Since the hyperbolic space has non-Euclidean geometric characteristics, it can represent hierarchical relationships between users and items more precisely. When degree-normalization is applied, central users at an upper hierarchy and popular items are stably distributed near a center of the hyperbolic space, while less popular items and low-activity user nodes at a lower hierarchy are naturally placed toward an outer region.

According to the results of FIG. 5, when degree-normalization is applied, the model clearly distinguishes boundaries between user groups and item groups, and an internal cohesion of groups having the same preference patterns appears high. Such structural improvement contributes to simultaneously enhancing recommendation quality and personalization performance.

In contrast, when the model does not apply degree-normalization, distributions of user nodes and item nodes in the hyperbolic space appear imbalanced and distorted. In particular, an influence of high-degree nodes becomes excessively large such that specific popular items are densely concentrated near a center of the hyperbolic space, while item nodes having relatively low degrees and low-activity user nodes are scattered toward an outer region of the space. In this case, as popular item nodes are excessively concentrated at the center, the model distorts relative distance information with other item nodes, and thus items that are not actually semantically similar may be artificially placed at close distances, thereby degrading recommendation accuracy.

In addition, if the model does not apply degree-normalization, it cannot sufficiently utilize non-Euclidean characteristics of the hyperbolic space, and limitations arise in expressing hierarchical structures. As a result, boundaries between an upper hierarchy and a lower hierarchy become ambiguous, and it becomes difficult to clearly distinguish latent relationships between items and users. When degree-normalization is not applied, user groups having the same tendency are located far apart from each other, and cohesion within item-node clusters is also weakened, which ultimately causes a decrease in prediction performance of the recommendation model.

As can be seen from FIG. 5, when degree-normalization is applied, the proposed hyperbolic-embedding-based recommendation model maintains distributions of user and item nodes in the hyperbolic space in a more stable and balanced manner and effectively learns complex relational structures. Accordingly, by performing node embedding while preserving hierarchical relationships, the model can more precisely model actual preference relationships between users and items, thereby improving recommendation accuracy. In addition, even when lower-hierarchy item nodes and new user nodes are placed at an outer region, the model alleviates a cold-start problem by maintaining relationships with upper-hierarchy nodes having similar tendencies. Finally, since the model reflects hierarchical information through distance-based embedding representations in the hyperbolic space, user nodes and item nodes having the same semantics are naturally located adjacent to each other, thereby maintaining semantic consistency.

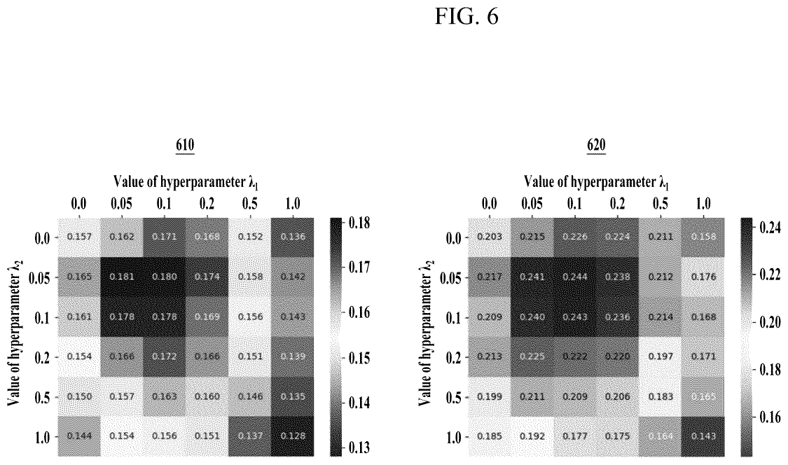

FIG. 6 is a diagram illustrating performance changes according to variation of hyperparameter values in one embodiment.

FIG. 6 visually represents experimental results performed in order to more clearly identify an influence of changes in hyperparameter settings on core model performance of the present invention.

In the present invention, model performance was measured while varying hyperparameters over multiple values, and major hyperparameters include a learning rate, a batch size, a regularization coefficient, an embedding dimension, and a dropout ratio. In the present invention, each hyperparameter was set to different values, and performance was measured under the same dataset and the same experimental conditions, and performance changes according to combinations of the hyperparameters were compared and analyzed.

In the present invention, model performance was evaluated on the basis of accuracy, recall, precision, and F1-score. As can be seen from the graph of FIG. 6, when the learning rate is increased in a specific interval, an optimization speed of the model becomes faster, but an overfitting phenomenon occurs and performance is degraded. Conversely, when the learning rate is set too low, a convergence speed of the model of the present invention becomes slow, and, in this case, the F1-score is recorded as the lowest.

In addition, in the present invention, when the batch size is set to be smaller, the model can learn detailed characteristics of data samples more precisely; however, an excessively small batch size degrades training stability. Conversely, when the batch size is set to be excessively large, generalization performance of the model tends to sharply deteriorate. In the present invention, an overfitting-suppression effect varied according to changes in the dropout ratio, and model performance was recorded as the highest when the dropout ratio was set in a range of about 0.3 to 0.4.

According to the results of FIG. 6, an optimal hyperparameter combination showing the best performance in the model of the present invention is configured with a learning rate of 1e−4, a batch size of 32, an embedding dimension of 256, a dropout ratio of 0.35, and a regularization coefficient of 1e−5. With this optimal combination, the model of the present invention exhibits the highest performance in both F1-score and accuracy, and achieves stable generalization performance without unnecessary overfitting.

Accordingly, through FIG. 6, the present invention clearly demonstrates that model performance can be maximized through hyperparameter optimization. The present invention improves training stability and enhances optimization speed, prevents overfitting and maximizes generalization performance, and secures high reliability when performing core functions of the model, while enabling dynamic tuning optimized to data characteristics by finely adjusting hyperparameter combinations.

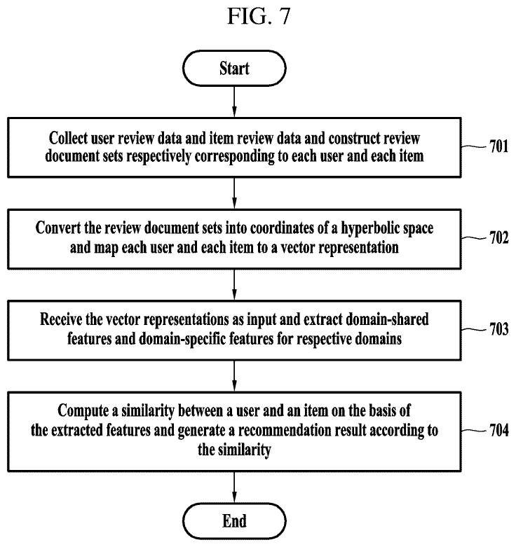

FIG. 7 is a flowchart illustrating a procedure of a recommendation method for inferring edge information in a hyperbolic space according to one embodiment.

More specifically, FIG. 7 visually represents an entire process of mapping vector representations of review data corresponding to users and items into a hyperbolic space, learning relationships between the users and the items, and inferring edge information in order to generate user-specific recommendation results.

In a recommendation method for inferring edge information in a hyperbolic space according to one embodiment, a recommendation system server may collect user review data and item review data and construct review document sets respectively corresponding to each user and each item (701). The recommendation system server collects review text data from a plurality of user terminals or external databases, and the review data may include metadata such as a user identifier, an item identifier, review content, a review rating, and a review creation time. The recommendation system server may group reviews for the same user and the same item from the collected review data and construct user-specific review document sets and item-specific review document sets.

In the recommendation method for inferring edge information in a hyperbolic space according to one embodiment, the recommendation system server may apply an embedding model to the review document sets and generate vector representations of each user review document and each item review document (702). The recommendation system server may utilize language models such as pre-trained BERT, RoBERTa, ELECTRA, and Sentence-BERT, or an embedding model proposed in the present invention, so as to reflect semantic information of the review documents into a vector space. The recommendation system server converts each user review document vector and each item review document vector into a fixed-dimensional (d-dimensional) latent vector space, and the vectors may be trained to preserve semantic similarity of review texts.

In the recommendation method for inferring edge information in a hyperbolic space according to one embodiment, the recommendation system server may map the generated user review document vectors and item review document vectors into the hyperbolic space and represent position vectors of the users and the items in the hyperbolic space (703).

The recommendation system server maps high-dimensional user and item vectors into the hyperbolic space by using a Poincare ball model or a Lorentz model based on hyperbolic geometry. The recommendation system server efficiently places user vectors and item vectors in the hyperbolic space according to depths of respective hierarchical structures so as to preserve hierarchical correlations and cross-domain features.

In a recommendation method for inferring edge information in a hyperbolic space according to one embodiment, the recommendation system server may calculate hyperbolic distances between the user vectors and the item vectors in the hyperbolic space and compute latent similarity scores on the basis thereof (704). The recommendation system server calculates distance values between the user and item vectors by using a Poincare distance or a Lorentz distance, and the distance values quantitatively represent relationship strengths between the users and the items. The recommendation system server converts the calculated hyperbolic distances into similarity scores by applying, for example, an inverse transformation or a softmax function, and the similarity scores are used as key indicators for evaluating candidate items.

In the recommendation method for inferring edge information in a hyperbolic space according to one embodiment, the recommendation system server may infer edge existence probabilities by integrating the hyperbolic-space distances between the users and the items and similarity information between the review document vectors. In one embodiment, the recommendation system server utilizes a link-prediction neural network model to probabilistically estimate existence of user-item edges and optimizes edge-inference accuracy by using a binary cross-entropy loss function during training. The recommendation system server selects candidate recommended items on the basis of the inferred edge existence probabilities and may include, in a recommendation list, only items whose probabilities are equal to or greater than a predetermined threshold.

In the recommendation method for inferring edge information in a hyperbolic space according to one embodiment, the recommendation system server may extract domain-shared features among a plurality of users and items and perform consistent edge-information inference even in a multi-domain environment. The recommendation system server analyzes common review patterns and item attributes across different domains such as e-commerce, video platforms, and music streaming services, and generates consistent vector representations in the hyperbolic space. The recommendation system server integrates edge-prediction results across multiple domains by using a trained model and may generate a user-specific recommended item list.

In the recommendation method for inferring edge information in a hyperbolic space, the recommendation system server may compute a recommended item list for each user on the basis of the edge information and provide the recommended item list to a user terminal. The recommendation system server provides recommendation results to the user terminal in real time according to a sorting criterion (for example, a similarity score, a predicted rating, a click probability, and the like), and may periodically retrain the model by re-collecting user feedback data.

In one embodiment, a recommendation processor calculates a hyperbolic-space distance between a user and an item and computes a similarity score by combining the calculated distance with a multilayer perceptron operation. The recommendation processor constructs a user representation and an item representation by combining shared features and domain-specific features output from a feature extractor, projects the combined representations into the hyperbolic space through an exponential map, and then calculates a hyperbolic-space distance as a Lorentz distance or a Poincare ball distance. The recommendation processor combines the hyperbolic distance with an output value of the multilayer perceptron to calculate a final similarity score, and the similarity score may be represented as a continuous value between 0 and 1.

The recommendation processor is trained so as to minimize a margin ranking loss defined by using a difference in hyperbolic distance between positive samples and negative samples. The recommendation processor selects, as positive samples, items observed for a single user and, as negative samples, sampled items among unobserved items, and updates parameters so as to satisfy a margin constraint on similarity scores for the positive-negative pairs.

The recommendation processor infers latent edge weights between user nodes and item nodes and updates a dynamic bipartite graph according to the edge weights. The recommendation processor interprets the similarity scores or the hyperbolic-distance-based scores as edge weights so as to reflect changes, over time, in connection strengths between users and items, and reflects latest interaction structures in internal representations by reusing the dynamic bipartite graph in subsequent training cycles.

The embedding processor and the feature extractor perform exponential maps and logarithmic maps in order to convert coordinates between the hyperbolic space and a Euclidean space. The exponential map projects a vector in a Euclidean tangent space onto a point on a hyperbolic manifold, and the logarithmic map inversely projects a point on the hyperbolic manifold onto a vector in the Euclidean tangent space. The embedding processor applies the exponential map to combined representations of word embeddings and document embeddings, and the feature extractor applies the logarithmic map in order to perform convolution operations in the tangent space so as to improve efficiency of convolutional neural network operations.

In one embodiment, the recommendation system is trained so as to minimize a total loss that is a weighted sum of a degree-normalization loss, a domain discrimination loss, and a margin ranking loss. The degree-normalization loss induces high-degree nodes to be kept closer to a center and low-degree nodes to be kept closer to a boundary by adjusting placement of hyperbolic radii according to a node-degree distribution. The domain discrimination loss maximizes domain separation performance for scale-aligned inputs and strengthens domain invariance of shared features through a gradient reversal layer. The margin ranking loss induces a hyperbolic-distance-based score difference between user-item positive pairs and negative pairs to be maintained above a margin. The recommendation system may secure convergence stability by applying a training procedure that includes an early-stopping criterion and a negative-sampling policy.

In one embodiment, the embedding processor uses a Poincare-GloVe embedding to learn word co-occurrence statistics in a distance-preserving manner, and constructs initial representations of users and items by aggregating the word embeddings at a document level. The feature extractor applies a logarithmic map to the initial representations, performs convolution operations in the tangent space, and applies a degree-normalization step to outputs of the convolution so as to adjust radii from a hyperbolic center to be inversely proportional to node degrees. The feature extractor applies scale alignment after the degree-normalization so as to remove magnitude information of feature vectors and improve distance-based separability with respect to a decision boundary of a domain discriminator. The recommendation processor combines a hyperbolic distance with multilayer perceptron operations to compute similarity scores and minimizes the margin ranking loss so as to satisfy a margin constraint on the similarity scores. This embodiment simultaneously achieves performance and stability of review-based cross-domain recommendation by combining hyperbolic embedding, hierarchy-preserving alignment, and scale alignment.

The recommendation system can internalize rich textual information of review documents while preserving a hierarchical structure of a user-item bipartite graph by utilizing negative-curvature characteristics of the hyperbolic space. The degree-normalization step may maximize radius-dependent expressiveness by inducing central convergence of high-degree nodes and boundary placement of low-degree nodes. The scale-alignment step may suppress unstable convergence caused by magnitude covariance of inputs to the domain discriminator and thereby simultaneously improve domain separation performance and domain invariance of shared features. The combination of the hyperbolic distance and the multilayer perceptron may improve resolution of similarity estimation by simultaneously reflecting distance-based hierarchical information and nonlinear interaction information. The dynamic bipartite graph update may secure temporal consistency of recommendation by immediately reflecting latest interaction changes in internal representations and training distributions.

The apparatus described above may be implemented as hardware components, software components, and/or a combination of hardware components and software components. For example, the apparatuses and components described in the embodiments may be implemented by using one or more general-purpose computers or special-purpose computers that are capable of executing and responding to instructions, such as a processor, a controller, an ALU (Arithmetic Logic Unit), a digital signal processor (DSP), a microcomputer, an FPGA (Field Programmable Gate Array), a PLU (Programmable Logic Unit), a microprocessor, or any other device capable of executing instructions. The processing device may execute an operating system (OS) and one or more software applications running on the operating system. In addition, the processing device may, in response to execution of software, access, store, manipulate, process, and generate data. For convenience of explanation, a single processing device may be described as being used; however, those skilled in the art will appreciate that the processing device may include a plurality of processing elements and/or a plurality of types of processing elements. For example, the processing device may include a plurality of processors, or one processor and one controller. Other processing configurations, such as parallel processors, are also possible.

Software may include a computer program, code, instructions, or one or more combinations thereof, and may configure the processing device to operate in a desired manner or command the processing device, individually or collectively, to operate in a desired manner. The software and/or data may be embodied, permanently or temporarily, in any type of machine, component, physical device, virtual equipment, computer storage medium or device, or transmitted signal wave in order to be interpreted by the processing device or to provide instructions or data to the processing device. The software may be distributed over computer systems connected via a network and may be stored or executed in a distributed manner. The software and data may be stored on one or more computer-readable recording media.

A method according to an embodiment may be implemented in the form of program instructions that can be performed through various computer means and may be recorded on a computer-readable medium. The computer-readable medium may include program instructions, data files, data structures, or combinations thereof. The program instructions recorded on the medium may be those specially designed and configured for the embodiments or may be those known and available to those skilled in computer software. Examples of the computer-readable recording medium include magnetic media such as hard disks, floppy disks, and magnetic tapes; optical media such as CD-ROMs and DVDs; magneto-optical media such as floptical disks; and hardware devices specially configured to store and execute program instructions, such as ROM, RAM, and flash memory. Examples of the program instructions include not only machine code generated by a compiler but also high-level language code that can be executed by a computer using an interpreter or the like. The above-described hardware devices may be configured to operate as one or more software modules to perform operations of the embodiments, and vice versa.

Although the embodiments have been described above with reference to limited drawings, those skilled in the art will understand that various modifications and variations are possible from the above description. For example, the described techniques may be performed in an order different from the described order, and/or components of the described systems, structures, devices, and circuits may be combined or arranged in forms different from those described, or may be replaced or substituted with other components or equivalents, while still achieving appropriate results.

Accordingly, other implementations, other embodiments, and equivalents to the claims are also within the scope of the claims set forth below.

What is claimed is:

1. A recommendation system for inferring edge information in a hyperbolic space, the system comprising:
a data receiver configured to collect user review data and item review data and to construct review document sets respectively corresponding to each user and each item;
an embedding processor configured to convert the review document sets into coordinates of a hyperbolic space and to map each user and each item to a hyperbolic vector representation;
a feature extractor configured to receive the hyperbolic vector representations as input and to extract domain-shared features and domain-specific features for respective domains; and
a recommendation processor configured to compute a similarity between a user and an item on the basis of the extracted features and to generate a recommendation result according to the similarity.

2. The recommendation system of claim 1, wherein the embedding processor is configured to convert the review document sets into the coordinates of the hyperbolic space by using a Poincare-GloVe embedding.

3. The recommendation system of claim 1, wherein the feature extractor comprises a shared feature extractor configured to extract the domain-shared features, a source feature extractor configured to extract source-domain-specific features, and a target feature extractor configured to extract target-domain-specific features.

4. The recommendation system of claim 3, wherein the shared feature extractor, the source feature extractor, and the target feature extractor are configured to extract features from the input hyperbolic vector representations by using a multi-channel convolutional neural network (CNN).

5. The recommendation system of claim 1, wherein the feature extractor is further configured to perform a degree-normalization step of applying, to the extracted features, weights that are inversely proportional to degrees of nodes so as to adjust distances from a hyperbolic center.

6. The recommendation system of claim 1, wherein the system is further configured to perform a scale alignment step of removing magnitude information of the features extracted by the feature extractor so as to improve separability of a domain discriminator.

7. The recommendation system of claim 1, wherein the recommendation processor is configured to calculate a hyperbolic-space distance between the user and the item, and to compute the similarity score by combining the calculated distance with a multilayer perceptron operation.

8. The recommendation system of claim 7, wherein the recommendation processor is trained so as to minimize a margin ranking loss defined by using a difference in hyperbolic distance between positive samples and negative samples.

9. The recommendation system of claim 1, wherein the recommendation processor is configured to infer latent edge weights between a user node and an item node and to update a dynamic bipartite graph according to the inferred edge weights.

10. The recommendation system of claim 1, wherein the embedding processor and the feature extractor are configured to perform an exponential map and a logarithmic map to convert coordinates between the hyperbolic space and a Euclidean space.

11. The recommendation system of claim 1, further comprising a domain discriminator configured to receive the domain-shared features and the domain-specific features extracted by the feature extractor and to perform domain separation.

12. A recommendation method for inferring edge information in a hyperbolic space, the method comprising:
collecting user review data and item review data and constructing review document sets respectively corresponding to each user and each item;
converting the review document sets into coordinates of a hyperbolic space and mapping each user and each item to a hyperbolic vector representation;
receiving the hyperbolic vector representations as input and extracting domain-shared features and domain-specific features for respective domains; and
computing a similarity between a user and an item on the basis of the extracted features and generating a recommendation result according to the similarity.

13. The recommendation method of claim 12, wherein converting the review document sets into the coordinates of the hyperbolic space comprises converting the review document sets into the coordinates of the hyperbolic space by using a Poincare-GloVe embedding.

14. The recommendation method of claim 12, wherein extracting the domain-shared features and the domain-specific features comprises a shared feature extraction step of extracting the domain-shared features, a source feature extraction step of extracting source-domain-specific features, and a target feature extraction step of extracting target-domain-specific features.

15. The recommendation method of claim 14, wherein the shared feature extraction step, the source feature extraction step, and the target feature extraction step comprise extracting features from input hyperbolic vector representations by using a multi-channel convolutional neural network (CNN).

16. The recommendation method of claim 12, wherein extracting the domain-shared features and the domain-specific features comprises performing a degree-normalization step of applying, to the extracted features, weights that are inversely proportional to degrees of nodes so as to adjust distances from a hyperbolic center.

17. The recommendation method of claim 12, wherein generating the recommendation result comprises calculating a hyperbolic-space distance between the user and the item and computing a similarity score by combining the calculated distance with a multilayer perceptron operation.

18. The recommendation method of claim 17, wherein generating the recommendation result further comprises training so as to minimize a margin ranking loss defined by using a difference in hyperbolic distance between positive samples and negative samples.
